(19) United States
(12) Patent Application Publication
(10) Pub. No.: US 2022/0101195 A1
(43) Pub. Date: Mar. 31, 2022

(54) MACHINE LEARNING SYSTEM AND MACHINE LEARNING METHOD

(71) Applicant: INSTITUTE FOR INFORMATION INDUSTRY, Taipei (TW)

(72) Inventors: Ping-Feng WANG, Taipei (TW); Jerry Chi-Yuan CHOU, Taipei (TW); Keng-Jui HSU, Taipei (TW); Chiun-Sheng HSU, Taipei (TW)

(21) Appl. No.: 17/093,591

(22) Filed: Nov. 9, 2020

(30) Foreign Application Priority Data
Sep. 30, 2020 (TW) 109134256

(51) Int. Cl. G06N 20/00; H04L 12/24

(52) U.S. Cl. CPC G06N 20/00; H04L 41/0803

(57) ABSTRACT

A machine learning system includes a host device and several client devices. The client devices receive a host model from the host device, respectively, and include a first and a second client devices. The first and the second client devices store a first and a second parameter sets, respectively, and perform training on the received host models according to the first and the second parameter sets, respectively, to respectively generate a first and a second training results. If the host device has received the first training result corresponding to an m-th training round but has not received the second training result corresponding to a n-th round training, when a difference between m and n is not higher than a threshold value, the host device updates the host model according to the first training result without using the second training result.

### RELATED APPLICATION

The present application claims priority to Taiwan Application Serial Number 109134256, filed Sep. 30, 2020, which is incorporated herein by reference in its entirety.

### BACKGROUND

### Technical Field

The present disclosure relates to a machine learning system and machine learning method. More particularly, the present disclosure relates to a federated machine learning system and machine learning method.

### Description of Related Art

In recent years, affected by the importance of data privacy in various countries, traditional machine learning methods that require gathering training data in a machine or data center have faced data collecting challenges, such that federated learning that can train models in their respective equipment gradually becomes a trend.

### SUMMARY

One aspect of the present disclosure is to provide a machine learning system, which includes a host device and a number of client devices. The host device is configured to store a host model, and is configured to update the host model one or multiple times. The client devices are configured to be communicatively coupled the host device so as to receive the host model, in which the client devices include a first client device and a second client device. The first client device storing a first parameter set is configured to train the received host model according to the first parameter set to generate a first training result. The second client device storing a second parameter set is configured to train the received host model according to the second parameter set to generate a second training result, in which under a condition that the host device receives the first training result of the first client device corresponding to an m-th training round but not receive the second training result of the second client device corresponding to a n-th training round, when the difference between m and n is not larger than a threshold value, the host device updates the host model with the first training result corresponding to the m-th training round but not with the second training result corresponding to the n-th training round, wherein m and n are positive integers, and m is larger than n.

Some aspects of the present disclosure provide a machine learning system including a host device and a number of client devices. The host device is configured to store and update a host model one or multiple times. The client devices are configured to be communicatively coupled the host device so as to receive the host model, in which each of the client devices is configured to train the received host model according to a corresponding one of a number of parameter sets to generate a training result, in which the host device stores a number of round numbers respectively corresponding to the client devices, and when the host device receives the training result of one of the client devices, the host device updates a corresponding one of the round numbers, in which in an i-th update that the host device conducts to the host model, when a difference between a maximum and a minimum of the round numbers is not larger than a threshold value, and the host device does not receive the training result transmitted from one of the client devices corresponding to the minimum of the round numbers, the host device updates the host model according to the training results that are already received in the i-th update, and i is a positive integer.

Some aspects of the present disclosure provide a machine learning method including: transmitting a host model, by a host device, to a number of client devices, in which the host device is configured to store and update the host model one or multiple times; training the host model, by each of the client devices, according to a corresponding parameter set to generate a training result; when the host device receiving the training result of one of the client devices, the host device updating a corresponding one of a number of round numbers respectively corresponding to the client devices and stored in the host device; in an i-th update that the host device conducting to the host model, when a difference between a maximum and a minimum of the round numbers is not larger than a threshold value, and the host device does not receive the training result transmitted from one of the client devices corresponding to the minimum of the round numbers, the host device updating the host model according to the training results that are already received in the i-th update, in which i is a positive integer.

It is to be understood that both the foregoing general description and the following detailed description are by examples, and are intended to provide further explanation of the disclosure as claimed.

### BRIEF DESCRIPTION OF THE DRAWINGS

FIG. 1 is a schematic diagram of a machine learning system, in accordance with some embodiments of the present disclosure.

FIG. 2 is a flow chart of a machine learning method, in accordance with some embodiments of the present disclosure.

FIG. 3 is a flow chart of details of the step S210 illustrated in FIG. 2, in accordance with an embodiment of the present disclosure.

### DETAILED DESCRIPTION

All the terms used in this document generally have their ordinary meanings. The examples of using any terms discussed herein such as those defined in commonly used dictionaries are illustrative only, and should not limit the scope and meaning of the disclosure. Likewise, the present disclosure is not limited to some embodiments given in this document.

The term “coupled” or “connected” in this document may be used to indicate that two or more elements physically or electrically contact with each other, directly or indirectly. They may also be used to indicate that two or more elements cooperate or interact with each other.

The index 1-k in the component numbers and signal numbers used in the specification and drawings of the present disclosure are just for the convenience of referring to individual components and signals, and it is not intended to limit the number of the aforementioned components and signals to a specific number. In the specification and drawings of present disclosure, if a component number or signal number is used without specifying the index of the component number or signal number, it means that the component number or signal number refers to any component or signal of the component group or signal group. For example, the element referred to the component number 1201 is the client device 1201, and the element referred to the component number 120 is an unspecified arbitrary client device among the client devices 1201-120k.

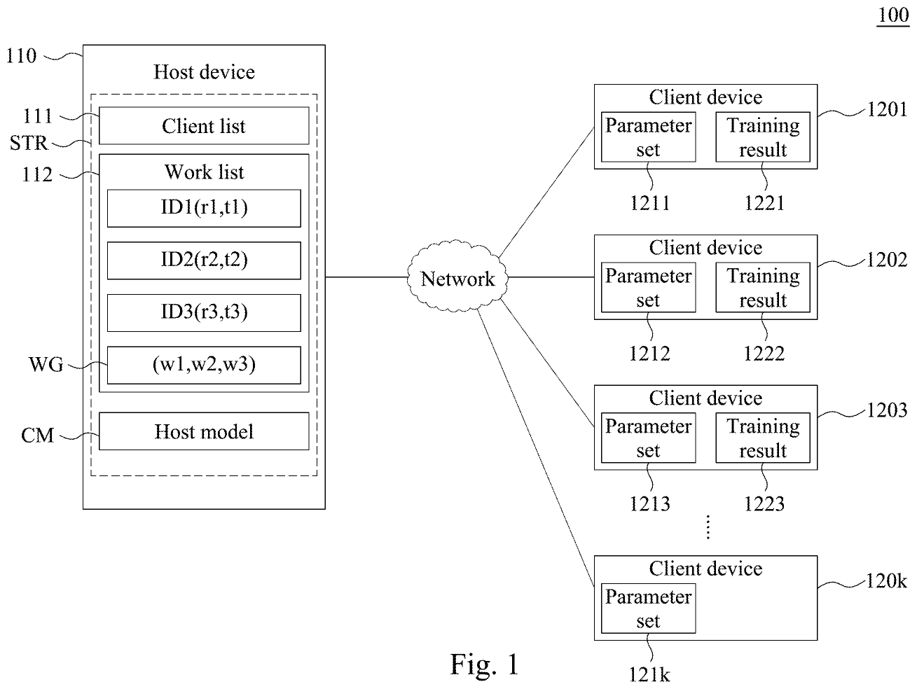

Reference is now made to FIG. 1. FIG. 1 is a schematic diagram of a machine learning system 100, in accordance with some embodiments of the present disclosure. As shown in FIG. 1, the machine learning system 100 includes a host device 110 and a number of client devices 1201-120k. The host device 110 is communicatively coupled to the client devices 1201-120k through internet or other networks, respectively.

In some embodiments, the host device 110 includes a host storage unit STR. The host storage unit STR is configured to store a client list 111, and the client list 111 is configured to record the client devices 1201-120k that are currently connected to the host device 110. When an additional client device 120 is added and connected to the host device 110, or an existing client device 120 is disconnected with the host device 110, the host device 110 will correspondingly add or remove an identifier (ID) corresponding to the client device 120 to/from the client list 111.

In some embodiments, the host storage unit STR is further configured to store a work list 112. The host device 110 may select part of or all of the client devices 120 from the client list 111, and store the identifiers IDs and weight values of the selected client devices 120 to the work list 112, so as to use the selected client devices 120 for predetermined rounds (e.g., 30 rounds) of training and generate training results 122 configured to be transmitted to the host device 110 in each training round. In practice, the training results 122 may be presented in various forms such as models, functions, parameters, etc., and may be used to update a host model CM of the host device 110. In other words, the host device 110 uses the client devices 120 on the work list 112 to perform federated machine learning. For instance, after the client devices 1201-120k are connected to the host device 110 and stored in the client list 111, the host device 110 may select the client devices 1201, 1202 and 1203 from the client list 111 to participate training, and establish the work list 112 including identifiers ID1-ID3 respectively corresponding to the client devices 1201, 1202 and 1203 and a weight group WG. In some embodiments, the host device 110 selects the client devices 120 from the client list 111 to be on the work list 112 according to a parameter set 1211-121k, resource usage conditions, etc., included in the client devices 1201-120k. It should be noted that to simplify the description, the selected client devices 120 on the work list 112 and the number thereof are only an example, and the present disclosure is not limited thereto.

In some embodiments, the host device 110 may also add all the connected client devices 1201-120k to the work list 112 without said selection in order to use all the client devices 1201-120k currently connected for following procedures and actions.

In some embodiments, each identifier ID further corresponds to a round number and a time stamp. For instance, as shown in FIG. 1, the client device 1201 corresponds to the identifier ID1, and the identifier ID1 corresponds to the round number r1 and the time stamp t1; the client device 1202 corresponds to the identifier ID2, and the identifier ID2 corresponds to the round number r2 and the time stamp t2, and so on. In some embodiments, the weight group WG includes weight values corresponding to the identifiers IDs, respectively. For instance, when the work list 112 includes three client devices respectively corresponding to the identifiers ID1-ID3, the weight group WG may include three weight values w1-w3 respectively corresponding to the identifiers ID1-ID3. In other words, the host device 110 may set a weight value for each of the client devices 120 selected to the work list 112. In some embodiments, the round numbers r1-r3 and the time stamps t1-t3 are all positive integers. In some other embodiments, a sum of the weight values w1-w3 in the weight group WG is 100%.

In some embodiments, the host storage unit STR is further configured to store a host model CM. When the work list 112 is established by the host device 110, in each training epoch, the host device 110 may transmit the host model CM to the client devices 120 (i.e., all of the client devices 120 on the work list 112) that are configured to perform federated machine learning Each of the client devices 120 uses the parameter set 121 thereof to train the received host model CM, in order to generate training results 122 of the multiple training rounds. In detail, after the client device 1201 receives the host model CM, the parameter set 1211 is used to train the host model CM to generate a training result 1221; similarly, after the client device 1202 receives the host model CM, the parameter set 1212 is used to train the host model CM to generate a training result 1222, and so on, after the client device 1203 receives the host model CM, the parameter set 1213 is used to train the host model CM to generate a training result 1223. It should be noted that the client devices 120 may use the parameter sets 121 to conduct different operations or trainings to the host model CM such as machine learning, deep learning, etc., and the present disclosure is not limited thereto. Furthermore, the client devices 120 that are not selected to the work list 112 (e.g., the client devices 1204-120k) do not participate in the training of the host model CM, and thus they would not transmit the training results to the host device 110.

In some embodiments, affected by factors such as the number or size of the parameter sets 121 and hardware equipment, the training speed of the client devices 120 will be different, and the time point of transmitting the training results 122 will also be different. Therefore, in some embodiments, after receiving at least part of the training results 122, the host device 110 may use the received training results 122 to update the host model CM stored in the host device 110 in order to increase training efficiency. In other words, the host device 110 may update the host model CM stored in the host device 110 every time when the host device 110 receives the training result 122 transmitted by any of the client devices 120 on the work list 112, or update the host model CM stored in the host device 110 after receiving a predetermined amount of the training results 122.

In this situation, a threshold value (e.g., 10) may be set in the host device 110, and the threshold value is configured to limit an upper limit of a training round difference between each of the client devices 120 on the work list 112 for avoiding excessive training round difference between each of the client devices 120, and further prevent an inaccurate update result caused by the host model CM being affected too much by a certain client device 120. The training round difference is a difference of the training rounds (training times).

For instance, during procedures of an update that the host device 110 conducts to the host model CM, if the client device 1201 has completed a r1-th training round and transmitted the training result 1221 corresponding to the r1-th training round to the host device 110, but the host device 110 has not received the training result 1222 corresponding to a r2-th training round from the client device 1202, the round numbers r1 and r2-1 respectively corresponding to the client devices 1201 and 1202 are recorded on the work list 112. In this way, if the round numbers r1 and r2-1 are the highest round number and the lowest round number, respectively among every identifier ID, and a difference between the round numbers r1 and r2-1 is not larger than the threshold value mentioned above, the host device 110 may not wait for the training result 1222 corresponding to the r2-th round training being transmitted from the client device 1202, and directly use the training results 122 that have been received during such update to update the host model CM.

On the other hand, in the situation mentioned above, if the round numbers r1 and r2-1 are the highest round number and the lowest round number, respectively, among every identifier ID, and the difference between the round numbers r1 and r2-1 is larger than the threshold value, the host device 110 needs to wait for the training result 1222 corresponding to the r2-th round training being transmitted from the client device 1202, so as to use the training result 1222 and other training results 122 that have been received during such update to update the host model CM.

In summary, the client device 1201 having the round number r1 is the one that performs the most training rounds on the work list 112, and client device 1202 having the round number r2-1 is the one that performs the least training rounds on the work list 112. By setting the threshold value in the host device 110, the situation that the training procedures of the host model CM are excessively affected by the client device 1201 (i.e., the one that performs the most training rounds) may be avoided.

In some embodiments, when the host device 110 updates the host model CM, one or more of the training results 122 may be directly averaged to generate the updated host model CM according to an average result. In some embodiments, the host device 110 may also perform weighted average on one or more of the training results 122, such as respectively multiplying the training results 1221, 1222 and 1223 by corresponding weight values (e.g., w1=20%, w2=30%, w3=50%) to generate the updated host model CM according to the average result.

In some embodiments, when the host device 110 only use the training result 1221 corresponding to the identifier ID1 to update the host model CM, the training result 1221 may be multiplied by 20%/(20%) to generate the updated host model CM. In other words, as mentioned before, when the host device 110 updates the host model CM according to only part of the training results 122 corresponding to part of the identifiers IDs, the host device 110 may perform weighted average with only part of the weight values corresponding to said part of the identifiers IDs to update the host model CM with an adjusted weighted average formula in the update.

In some embodiments, after the host device 110 generates the updated host model CM, the host device 110 transmits the updated host model CM to all of the client devices 120 on the work list 112 such that the client devices 120 may use respective parameter sets 121 to train the new received host model CM. The aforementioned procedure may be repeated multiple times until all of the client devices 120 on the work list 112 complete respective predetermined training rounds. For instance, in the aforementioned situation of the host device 110 updating the host model CM without waiting the training result 1222 of the client device 1202, the host device 110 still transmits the updated host model CM to all of the client devices 1201, 1202 and 1203 on the work list 112 for the client devices 1201, 1202 and 1203 to train the updated host model CM.

In some embodiments, the time stamps t1-t3 are floating values, in which the time stamps t1-t3 are configured to calculate the time each of the client devices 120 have already used in a training round. In some embodiments, when one or more of the time stamps t1-t3 are larger than a preset time value, the host device 110 removes corresponding one or more of the identifiers ID1-ID3 from the work list 112. In some embodiments, each of the identifiers ID1-ID3 may correspond to the same or different preset time values.

For instance, when a preset time value corresponding to the identifier ID1 is 15 seconds, the time stamp t1 corresponding to the identifier ID1 will be counted in a sequence of “1, 2, 3 . . . ” If the client device 1201 corresponding to the identifier ID1 does not transmit the training result 1221 to the host device 110 before the time stamp t1 being greater than 15, the host device 110 determines that the client device 1201 is abnormal (e.g., abnormal connected), and removes the identifier ID1 from the work list 112 to no longer receive the training result 1221 corresponding to the identifier ID1. By the fault tolerance process, the host device 110 may prevent the federated machine learning process from being interrupted due to disconnections of the client devices 120, and thus enhances efficiency and stability of the learning process.

In some embodiments, when any identifier ID is removed from the work list 112, the host device 110 will adjust the weight group WG of the work list 112. In some embodiments, the weight value corresponding to the removed identifier ID may be set to 0 or be removed from the weight group WG, and the remaining weight values are updated such that a sum of the weight values corresponding to the identifiers IDs that are kept on the work list 112 remains 100%.

For instance, in some embodiments, when a time stamp of the client device 1201 corresponding to the identifier ID1 is greater than a preset time value, and thus the corresponding identifier ID1 is removed from the work list 112 by the host device 110, the weight values w2 and w3 respectively corresponding to the remaining identifiers ID2 and ID3 on the work list 112 may be proportionally adjusted from the original 30% and 50% to [30/(30+50)] X 100% and [50/(30+50)] X 100%, and the weight value w1 of the removed identifier ID1 is directly removed or set to 0. In some other embodiments, the weight values w2 and w3 corresponding to the remaining identifiers ID2 and ID3 may also be adjusted according to actual needs, and is not limited thereto.

In some embodiments, after the host device 110 establishes the work list 112, the host device 110 establishes an associated program with information of the work list 112, such information including the identifiers ID1-ID3 of the client devices 1201, 1202 and 1203, the round numbers r1-r3, the parameter sets 1211, 1212 and 1213, the training results 1221, 1222, 1223, etc., and stores the associated program in the host storage unit STR of the host device 110 to form a process pool. In other words, the host device 110 records, in the process pool, relevant information of the associated client device(s) 120 when every time the host device 110 updates the host model CM. In some embodiments, when the time stamp of the client device 1201 corresponding to the identifier ID1 is greater than a preset time value, and the corresponding identifier ID1 is removed from the work list 112 by the host device 110, the host device 110 may also remove part of or all of relevant information corresponding to the client device 1201 such as the identifier ID1, the round number r1, the parameter set 1211, the training result 1221, etc. stored in the process pool, accordingly.

In some other embodiments, the host device 110 may also select additional client devices 120 from the client list 111 to add to the work list 112, when the other client devices 120 perform training and generate the training results 122. In this way, the work list 112 includes identifiers, round numbers and time stamps corresponding to the newly added client devices, in which the operations are similar to those described in the previous paragraphs, for the sake of brevity, those descriptions will not be repeated here.

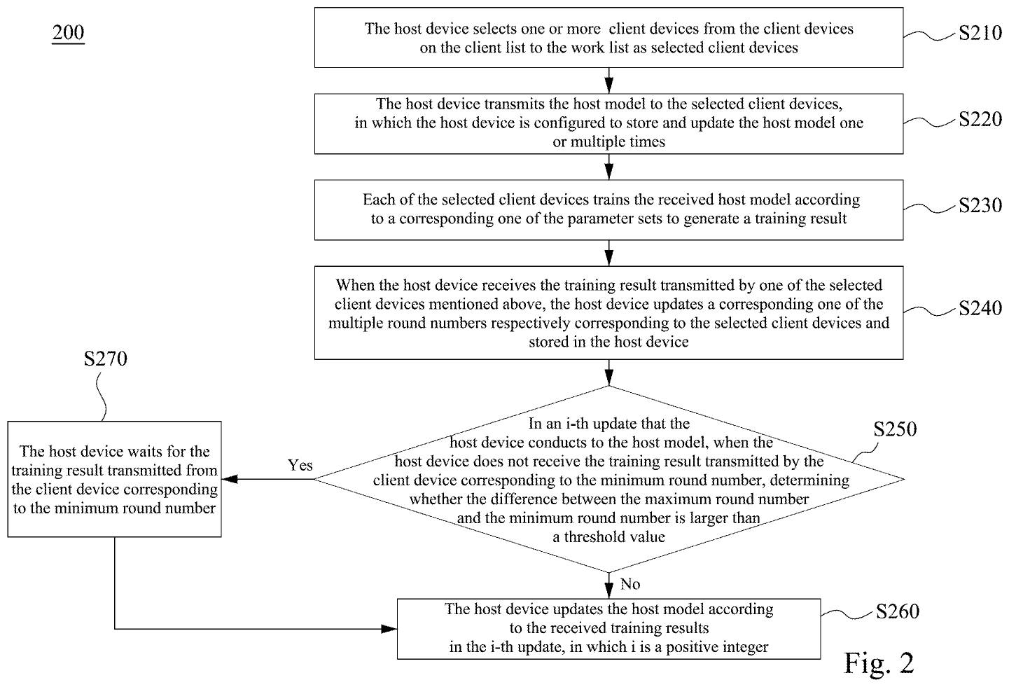

Reference is made to FIG. 2. FIG. 2 is a flow chart of a machine learning method 200, in accordance with some embodiments of the present disclosure. The machine learning method 200 is applicable to the machine learning system 100. As shown in FIG. 2, the machine learning method 200 includes step S210, S220, S230, S240, S250 and S260.

In step S210, as shown in FIG. 1, the host device110 selects one or more of the client devices 120 (e.g., the client devices 1201, 1202 and 1203) from the client devices 1201-120k of the client list 111 to the work list 112 as selected client devices. In some embodiments, the work list 112 further includes the weight values (e.g., the weight values w1, w2 and w3) corresponding to the selected client devices.

In step S220, the host device 110 transmits the host model CM to the selected client devices, in which the host device 110 is configured to store and update the host model CM one or multiple times.

In step S230, each of the selected client devices trains the received host model CM according to a corresponding one of the parameter sets (e.g., the parameter sets 1221, 1222 and 1223) to generate a training result. The corresponding parameter sets mentioned above are stored in the selected client devices, respectively.

In step S240, when the host device 110 receives the training result transmitted by one of the selected client devices mentioned above, the host device 110 updates a corresponding one of the multiple round numbers (e.g., the round numbers r1, r2 and r3) respectively corresponding to the selected client devices and stored in the host device 110.

In step S250, in an i-th update that the host device 110 conducts to the host model CM, when the host device 110 does not receive the training result transmitted by the client device 120 corresponding to the minimum round number, the host device 110 determines whether the difference between the maximum round number and the minimum round number is larger than a threshold value.

In step S260, if the host device 110 determines the difference between the maximum round number and the minimum round number is not larger than the threshold value in step S250, the host device 110 updates the host model CM according to the received training results in the i-th update, in which i is a positive integer. In some embodiments, the host device 110 may directly average the received training results to update the host model CM. In some embodiments, the host device 110 may also perform weighted average on the received training results 122 according to the weight values corresponding to each of the selected client devices to update the host model CM.

In some embodiments, the machine learning method 200 further includes step S270. When the host device 110 determines the difference between the maximum round number and the minimum round number is larger than the threshold value in step S250, the host device 110 performs step S270 to wait for the training result transmitted from the client device 120 corresponding to the minimum round number. After step S270 is ended, the host device 110 performs step S260. In some embodiments, during the period of waiting for the training result transmitted from the client device 120 corresponding to the minimum round number, the host device 110 may further receive training results transmitted from other devices.

In some embodiments, the machine learning method 200 further includes initializing the host device 110 and connecting the client devices 1201-120k to the host device 110 to establish the client list 111.

In some embodiments, between step S210 and step S270 of the machine learning method 200, the host device 110 establishes an associated program according to information of the selected client device, such information includes the identifiers ID1-ID3 of the client devices 1201, 1202 and 1203, the round numbers r1-r3, the parameter sets 1211, 1212 and 1213, the training results 1221, 1222, 1223, etc., and stores the associated program in the host storage unit STR of the host device 110 to form a process pool. In other words, the host device 110 records, in the process pool, relevant information of the associated client device(s) 120 when every time the host device 110 updates the host model CM. In some embodiments, the identifiers IDs are configured to record identities of the selected client devices; the round numbers are configured to record the times that the selected client devices conducting trainings and generating the training results; the parameter sets are configured to record data sources used by the selected client devices to generate the training results; and the training results are configured to be collected by the host device 110 to update the host model CM.

In some embodiments, during the period of performing step S250 to step S270, the machine learning method 200 may perform step S240 in parallel (or multiple times) to continue receiving the training result transmitted from one of the selected client devices.

In some embodiments, the machine learning method 200 returns to step S210 or step S220 after completing step S270 to repeat the procedures mentioned above.

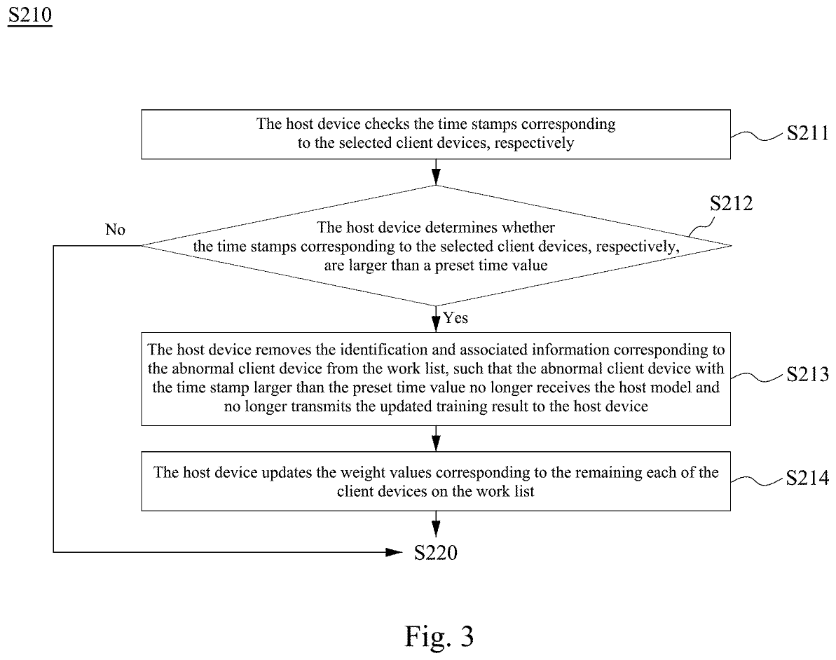

FIG. 3 is a flow chart of details of the step S210 illustrated in FIG. 2, in accordance with an embodiment of the present disclosure. In some embodiments, step S210 further includes step S211-S213. In step S211, the host device 110 checks the time stamps corresponding to each of the selected client devices, and the time stamps are configured to calculate time usage for each training round of the selected client devices. In step S212, the host device 110 determines whether the time stamps (e.g., the time stamps t1-t3) corresponding to each of the selected client devices are larger than a preset time value so as to instantly confirm whether the selected client devices have abnormal conditions such as network disconnections. In some embodiments, if the host device 110 determines that one of the selected client devices with the time stamp larger than the preset time value is an abnormal client device, the host device 110 proceeds to step S213. In step S213, the host device 110 removes the identifier and associated information corresponding to the abnormal client device from the work list 112, such that the abnormal client device with the time stamp larger than the preset time value no longer receives the host model CM and no longer transmits the updated training result to the host device 110.

In some embodiments, step S210 further includes step S214. In step S214, the host device 110 updates the weight values corresponding to the remaining each of the client devices 120 on the work list 112. In detail, the sum of the weight values that the selected client devices originally have is 100%. If one of the selected client devices is removed from the work list 112, the weight values of the remaining each of the client devices 120 on the work list 112 need to be adjusted, accordingly, such that the sum of the weight values of the remaining each of the client devices 120 is 100%.

Based on above, the machine learning system 100 and the machine learning method 200 provided by the present disclosure, by controlling a difference of the round numbers between each of the client devices, render each of the client devices may generate training results asynchronously under the difference of the round numbers not greater than the threshold value, so as to reduce the time waste caused by each client device waiting for each other, and alleviate the problem that the accuracy of the host model is affected by excessive differences of the round numbers between each client device. In addition, by calculating the time for each client device to perform each training round, and by removing the corresponding client device from the work list when the time stamp is greater than the preset value, the whole learning process may be prevent from being affected when the client device is abnormal or interrupted. Furthermore, the impact for the training results of each of the client devices on the host model may be adjusted by rendering every client devices correspond to the same or different weight values.

While the disclosure has been described by way of example(s) and in terms of the preferred embodiment(s), it is to be understood that the disclosure is not limited thereto. Those skilled in the art may make various changes, substitutions, and alterations herein without departing from the spirit and scope of the present disclosure. In view of the foregoing, it is intended that the present invention cover modifications and variations of this invention provided they fall within the scope of the following claims.

What is claimed is:

1. A machine learning system comprising:
a host device configured to store a host model, and configured to update the host model one or multiple times; and
a plurality of client devices configured to be communicatively coupled to the host device and receive the host model, the plurality of client devices comprising:
a first client device storing a first parameter set, and configured to train the received host model according to the first parameter set to generate a first training result; and
a second client device storing a second parameter set, and configured to train the received host model according to the second parameter set to generate a second training result;
wherein under a condition that the host device receives the first training result of the first client device corresponding to an m-th training round but not receive the second training result of the second client device corresponding to a n-th training round, when the difference between m and n is not larger than a threshold value, the host device updates the host model with the first training result corresponding to the m-th training round but not with the second training result corresponding to the n-th training round, wherein m is larger than n.

2. The machine learning system of claim 1, wherein under the condition that the host device receives the first training result of the first client device corresponding to the m-th training round but not receive the second training result of the second client device corresponding to the n-th training round, when the difference between m and n is not larger than the threshold value, the host device is held to receive the second training result corresponding to the n-th training round to update the host model with the first training result corresponding to the m-th training round and the second training result corresponding to the n-th training round.

3. The machine learning system of claim 1, wherein the first client device performs the most training rounds among the plurality of client devices, and the second client device performs the least training rounds among the plurality of client devices.

4. The machine learning system of claim 1, wherein the host device further performs a weight-mean calculation according to the first training result, a first weight value corresponding to the first client device, the second training result and a second weight value corresponding to the second client device so as to update the host model.

5. The machine learning system of claim 1, wherein the host device comprises a host storage unit, and the host storage unit is configured to store at least one preset time value and a plurality of identifiers (IDs) respectively corresponding to the plurality of client devices, wherein
when the host device not receiving the first training result exceeding a corresponding one of the at least one preset time value, the host device removes one of the plurality of identifiers that corresponds to the first client device to generate updated identifiers, and no longer receives the first training result.

6. The machine learning system of claim 5, wherein each of the plurality of client devices trains the host model thereof according to a corresponding one of a plurality of parameter sets so that a plurality of training results are generated, the plurality of parameter sets comprise the first parameter set and the second parameter set, and the plurality of training results comprise the first training result and the second training result, wherein
the host storage unit is further configured to store a weight group corresponding to the plurality of identifiers, and the host device performs the weight-mean calculation on the plurality of training results according to the weight group so as to update the host model of the host device, wherein
when the host device not receiving the first training result exceeding the corresponding one of the at least one preset time value, the host device updates every weight value in the weight group according to the updated identifiers.

7. A machine learning system comprising:
a host device configured to store and update a host model one or multiple times; and
a plurality of client devices configured to be communicatively coupled to the host device and receive the host model, wherein each of the plurality of client devices is configured to train the received host model according to a corresponding one of a plurality of parameter sets to generate a training result; wherein
the host device stores a plurality of round numbers respectively corresponding to the plurality of client devices, and when the host device receives the training result of one of the plurality of client devices, the host device updates a corresponding one of the plurality of round numbers, wherein
in an i-th update that the host device conducts to the host model, when a difference between a maximum and a minimum of the plurality of round numbers is not larger than a threshold value, and the host device does not receive the training result transmitted from one of the plurality of client devices corresponding to the minimum of the plurality of round numbers, the host device updates the host model according to the training results that are received in the i-th update, and i is a positive integer.

8. The machine learning system of claim 7, wherein when the difference between the maximum and the minimum of the plurality of round numbers is larger than the threshold value in the i-th update, the host device is configured to be held to receive the training result transmitted from the one of the plurality of client devices corresponding to the minimum of the plurality of round numbers, so as to update the host model according to the training result transmitted from the one of the plurality of client devices corresponding to the minimum of the plurality of round numbers and other training results that are received in the i-th update.

9. The machine learning system of claim 7, wherein a first client device of the plurality of client devices is configured to generate a first training result in each training round, and the host device comprises a host storage unit configured to store at least one preset time value and a plurality of identifiers respectively corresponding to the plurality of client devices, wherein
when the host device not receiving the first training result exceeding a corresponding one of the at least one preset time value, the host device removes one of the plurality of identifiers that corresponds to the first client device to generate updated identifiers, and no longer receives the first training result.

10. The machine learning system of claim 9, wherein the host storage unit is configured to store a weight group corresponding to the plurality of identifiers, and the host device performs a weight-mean calculation on the training results that are received in the i-th update according to the weight group so as to update the host model of the host device, wherein
when the host device not receiving the first training result exceeding the corresponding one of the at least one preset time value, the host device updates every weight value in the weight group according to the updated identifiers.

11. A machine learning method comprising:
transmitting a host model, by a host device, to a plurality of client devices, wherein the host device is configured to store and update the host model one or multiple times;
training the host model, by each of the plurality of client devices, according to a corresponding parameter set to generate a training result; and
updating, by the host device, a corresponding one of a plurality of round numbers respectively corresponding to the plurality of client devices and stored in the host device when the host device receives the training result of one of the plurality of client devices;
wherein in an i-th update that the host device conducts to the host model, when a difference between a maximum and a minimum of the plurality of round numbers is not larger than a threshold value, and the host device does not receive the training result transmitted from one of the plurality of client devices corresponding to the minimum of the plurality of round numbers, the host device updates the host model according to the training results that are received in the i-th update, wherein i is a positive integer.

12. The machine learning method of claim 11, wherein when the difference between the maximum and the minimum of the plurality of round numbers is larger than the threshold value in the i-th update, the host device is configured to be held to receive the training result transmitted from the one of the plurality of client devices corresponding to the minimum of the plurality of round numbers, so as to update the host model according to the training result transmitted from the one of the plurality of client devices corresponding to the minimum of the plurality of round numbers and remaining training results that are received in the i-th update.

13. The machine learning method of claim 11, wherein the host device updates the host model according to the training results that are received in the i-th update comprises:
performing a weight-mean calculation, by the host device, on the training results that are received in the i-th update according to a plurality of weight values corresponding to the plurality of client devices so as to update the host model.

14. The machine learning method of claim 11, wherein the host device stores at least one preset time value respectively corresponding to the plurality of client devices and a plurality of identifiers respectively corresponding to the plurality of client devices, and the machine learning method further comprises:
removing, by the host device, one of the plurality of identifiers that corresponds to the first client device to generate the updated plurality of identifiers, and removing one of the plurality of round numbers that corresponds to the first client device to no longer receive the first training result, when the host device not receiving a first training result, generated by a first client device of the plurality of client devices in each training round, exceeding a corresponding one of the at least one preset time value.

15. The machine learning method of claim 14, further comprising:
updating, by the host device, every weight value in a weight group according to the updated plurality of identifiers when the host device not receiving the first training result exceeding the corresponding one of the at least one preset time value.
